(19) United States
(12) Patent Application Publication
(10) Pub. No.: US 2026/0175198 A1
(43) Pub. Date: Jun. 25, 2026

(54) MODIFIED ALUMINOBORATES HAVING INCREASED SURFACE AREA AND METHODS OF MAKING

(71) Applicant: UOP LLC, Des Plaines, IL (US)

(72) Inventors: Kelsey L. Hodge, Hoffman Estates, IL (US); Allison Theberge, Chicago, IL (US); Yili Shi; Richard R. Willis, Cary, IL (US); Sesh Prabhakar, Hoffman Estates, IL (US)

(21) Appl. No.: 19/332,550

(22) Filed: Sep. 18, 2025

Related U.S. Application Data
(60) Provisional application No. 63/735,966, filed on Dec. 19, 2024.

(51) Int. Cl. B01J 21/02; B01J 27/25; B01J 35/61; B01J 35/63; B01J 37/08

(52) U.S. Cl. CPC B01J 21/02; B01J 27/25; B01J 35/615; B01J 35/633; B01J 37/08

(57) ABSTRACT

Salt modified aluminoborates and processes of producing them are described. The salt modified aluminoborate has a weight ratio of Al:B in the range of 1.5 to 2.5, and it has an XRD diffraction pattern substantially similar to the XRD pattern of known aluminoborates. It can be produced using temperatures in the range of 20° C. to 40° C. and a solid:liquid ratio of 1:20 to 1:100, or temperatures in the range of 50 to 100° C. and a solid:liquid ratio of 1:10 to 1:40 will produce a salt modified aluminoborate with the properties described below. Calcining the salt modified aluminoborate produces different XRD diffraction patterns depending on the temperature used for the calcining.

### RELATED APPLICATIONS

This application claims priority to U.S. Provisional Patent Application Ser. No. 63/735,966, filed on Dec. 19, 2024, the entirety of which is incorporated herein by reference.

### BACKGROUND

The use of aluminoborates and modified aluminoborates as catalysts is known in the literature. For example, the octahedra-based molecular sieve aluminoborate (PKU-1) was reported to be a catalyst for synthesis of α-aminonitriles from imines and TMSCN. (Wang et al., Octahedra-based molecular sieve aluminoborates (PKU-1) as solid acid catalyst for heterogeneously catalyzed Strecker reaction, Catalysis Communications 58 (2015) 174-178.) Fe- and Cr-modified aluminoborates are also known as catalysts. (Wang et al., Fe doped aluminoborate PKU-1 catalysts for the ketalization of glycerol to solketal: Unveiling the effects of iron composition and boron, Chinese Chemical Letters, 33 (2022) 1346-1352; Wang et al., Octahedron-based redox molecular sieves M-PKU-1 (M+Cr, Fe): A novel dual-centered solid acid catalyst for heterogeneously catalyzed Strecker reaction, Applied Catalysis A General 542 (2017) 24-251).

The Al:B weight ratio reported in the literature in in the range of about 1.12 to 1.24 (calculated values from information provided in the following articles) (Li et al., Systematic Study of Cr⁺³ Substitution into Octahedral-Based Microporous Aluminoborates, Inorganic Chemistry, 2014, 53, 5600-5608; and Ju et al., Aluminoborate-Based Molecular Sieves with 18-Octahedral-Atom Channels, Angew. Chem. Int. Ed., 2003, 42, 5607-5610).

While some aluminoborates and modified aluminoborates have been reported in the literature, they typically exhibit lower surface areas than might expected based on the structure.

There is a need for new aluminoborate materials having increased surface area and microporosity and methods for making them.

### BRIEF DESCRIPTION OF THE DRAWINGS

FIG. 1 is a comparison of the cumulative pore volume v. pore width for the parent aluminoborate, the acid-washed aluminoborate, and an ammonium nitrate modified aluminoborate.

FIG. 2 is a comparison of the XRD patterns of the parent aluminoborate, and an ammonium nitrate modified aluminoborate.

FIG. 3 is a comparison of the cumulative pore volume of parent aluminoborate, and an ammonium nitrate modified aluminoborate, with derivative plots of the parent aluminoborate, and an ammonium nitrate modified aluminoborate.

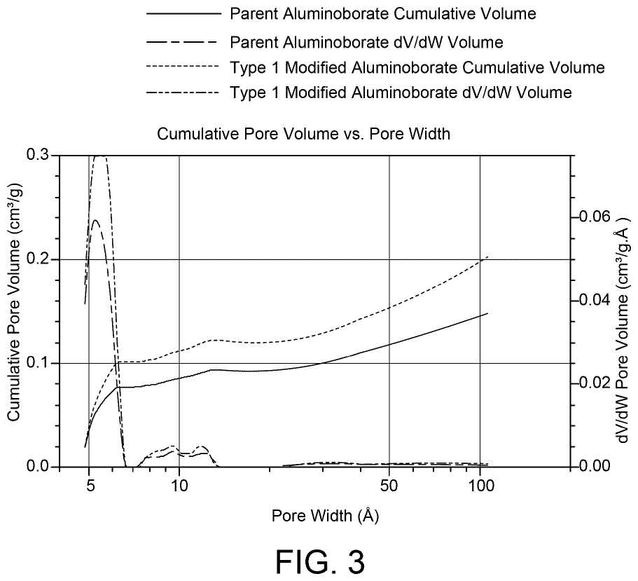

### DESCRIPTION

Although not wishing to be bound by theory, it is believed that the low surface area of the reported PKU-1 framework is due to H₃BO₃ clusters located within the pores of the material. By selectively removing what is in the pores of this material, the aluminoborates should exhibit higher microporosities. If this is accomplished with the PKU-1-like framework, this would also lead to a 1-dimentional microporous material.

Although not wishing to be bound by theory, it is believed that the process modifies the aluminoborate by selectively removing boron from the crystal structure to improve the surface area. This phenomenon has not been reported previously. The process uses ammonium and other soluble metal salts to remove boron from the crystal structure of the aluminoborate. This is very advantageous due to the increased microporosity and resulting increased surface area.

Two novel salt modified aluminoborates have been developed. The Type 1 salt modified aluminoborate has an Al:B ratio in the range of 1.5 to 2.5, while the Type 2 salt modified aluminoborates has an Al:B ratio in the range of 5 to 8. The XRD diffraction pattern of the Type 1 salt modified aluminoborate is substantially the same as the parent aluminoborate, while the Type 2 salt modified aluminoborate has a different XRD pattern from the parent. The calcined Type 1 and Type 2 salt modified aluminoborates have different XRD patterns from the parent aluminoborate.

Using 11B NMR, it was shown that the boron environment of the modified aluminoborates is changed relative to that of the parent aluminoborate. In the spectra, two distinct three-coordinate boron environments were observed, including two three coordinate boron environments and one four coordinate boron environment. The Type-1 modification has more of the BO₃-1 environment and less of the BO₃-2 environment compared to the parent aluminoborate. The Type-1 modification may have greater than or equal to 75% of the BO₃-1 environment, or greater than or equal to 80%, or greater than or equal to 85%. It may have less than or equal to 25% of the BO₃-2 environment, or less than or equal to 20%, or less than or equal to 15%. It may have less than or equal to 10% of the BO₄ environment.

Relative to the parent, the Type-2 modification had far less of the BO₃-1 environment and started to form some BO₄-coordinate boron. The Type-2 modification may have greater than or equal to 50% of the BO₃-2 environment, or greater than or equal to 60%, or greater than or equal to 70%, or greater than or equal to 75%, or greater than or equal to 80%, or greater than or equal to 85%, or greater than or equal to 90%. It may have less than or equal to 10% of the BO₃-1 environment. It may have less than or equal to 15% of the BO₄ environment.

TABLE 1

| Phase | BO₃-1 | BO₃-2 | BO₄ |
|---|---|---|---|
| Parent (PKU-1-like) | 57-70% | 30-43% | 0-10% |
| Type-1 | 77-91% | 9-23% | 0-10% |
| Type-2 | 0-10% | 84-95% | 0-15% |

The reaction conditions determine what type of salt modified aluminoborate is produced, which in turn determines its properties. U.S. Application Ser. No. 63/736,023, entitled Modified Aluminoborates Having Increased Surface Area and Methods of Making, filed Dec. 19, 2024, the entirety of which is incorporated herein by reference, describes one type of salt modified aluminoborate (Type 2). The conditions for making the Type 2 salt modified aluminoborate include temperatures in the range of 50° C. to 100° C. and a solid:liquid weight ratio of 1:50 to 1:200.

The present application is directed to the Type 1 salt modified aluminoborate. The conditions for producing the Type 1 salt modified aluminoborate include temperatures in the range of 20° C. to 40° C. and a solid:liquid weight ratio of 1:20 to 1:100, or temperatures in the range of 50 to 100° C. and a solid:liquid weight ratio of 1:10 to 1:40. It has increased total micropore volume, as well as a similar XRD diffraction pattern to that of the parent material with similar intensities. It has shown improved adsorption for trifluoroacetic acid (TFA) which is a PFAS by-product and considered a major contributor to PFAS contamination.

One aspect of the invention is a new salt modified aluminoborate. In one embodiment, the salt modified aluminoborate has a weight ratio of Al:B in a range of 1.5 to 2.5 compared to the Al:B weight ratio for the parent material of 1.25 to 1.48 (as tested-see Examples).

In some embodiments, the salt modified aluminoborate has a surface area of 147 m²/g to 443 m²/g compared to 56 m²/g to 178 m²/g for the parent material as tested.

In some embodiments, the salt modified aluminoborate has a total pore volume in a range of 0.18 cc/g to 0.4 cc/g.

In some embodiments, the salt modified aluminoborate has a mesopore volume in a range of 0.09 cc/g to 0.26 cc/g compared to 0.09 cc/g to 0.26 cc/g for the parent material as tested.

In some embodiments, the salt modified aluminoborate has a micropore volume in a range of 0.05 cc/g to 0.13 cc/g compared to 0.02 cc/g to 0.07 cc/g for the parent material as tested.

In some embodiments, the salt modified aluminoborate may be modified with any suitable water soluble salt. Suitable salts include, but are not limited to, salts of ammonium, Li, K, Na, Rb, Cs, Mg, Ca, Sr, Ba, or combinations thereof. Suitable anions for the salt include, but are not limited to, carbonate, bicarbonate, chloride, sulfate, sulfite, phosphate, phosphite, perchlorate, oxalate, nitrite, iodide, bromide, formate, fluoride, citrate, acetate, and the like.

In some embodiments, the salt modified aluminoborate may also include an M²⁺ cation or an M³⁺ cation. Suitable metals for the M²⁺ and M³⁺ cations include, but are not limited to, Mg, Ca, Ni, Mn, Co, Zn, Fe, Cr, Rh, Ga, In, Mn, Ti, La, or combinations thereof.

The XRD diffraction pattern for the salt modified aluminoborate (Table 3) is substantially similar to the XRD diffraction pattern for the parent aluminoborate (Table 2).

TABLE 2
Parent Material

| 2θ° | d-spacing Å | Intensity |
|---|---|---|
| 7.89-8.11 | 11.20-10.89 | vs |
| 13.28-13.56 | 6.66-6.52 | vw |
| 13.77-14.04 | 6.43-6.30 | w |
| 15.49-15.80 | 5.72-5.60 | vw |
| 15.91-16.23 | 5.57-5.46 | vw |
| 17.45-17.77 | 5.08-4.99 | vw |
| 20.81-21.17 | 4.26-4.19 | vw |
| 21.15-21.50 | 4.20-4.13 | vw |
| 22.32-22.68 | 3.98-3.92 | vw |
| 23.71-24.11 | 3.75-3.69 | vw |
| 24.05-24.42 | 3.70-3.64 | vw |
| 25.56-25.96 | 3.48-3.43 | vw |
| 27.57-27.97 | 3.23-3.19 | vw |
| 28.00-28.40 | 3.18-3.14 | vw |
| 28.76-29.18 | 3.10-3.06 | w |
| 30.29-30.72 | 2.95-2.91 | w |
| 30.96-31.39 | 2.89-2.85 | vw |
| 32.27-32.73 | 2.77-2.73 | vw |
| 33.07-33.51 | 2.71-2.67 | vw |
| 35.26-35.76 | 2.54-2.51 | vw |
| 35.96-36.46 | 2.50-2.46 | vw |

TABLE 3
Type 1 Uncalcined

| 2θ ° | d-spacing Å | Intensity |
|---|---|---|
| 7.89-8.01 | 11.19-11.03 | vs |
| 13.28-13.44 | 6.66-6.58 | vw |
| 13.77-13.93 | 6.42-6.35 | vw-w |
| 15.50-15.68 | 5.71-5.65 | vw |
| 15.93-16.12 | 5.56-5.49 | vw |
| 17.44-17.64 | 5.08-5.02 | vw |
| 20.79-21.02 | 4.27-4.22 | vw |
| 21.13-21.38 | 4.20-4.15 | vw |
| 22.31-22.56 | 3.98-3.94 | vw |
| 23.72-23.97 | 3.75-3.71 | vw |
| 24.02-24.36 | 3.70-3.65 | vw |
| 25.57-25.86 | 3.48-3.44 | vw |
| 27.54-27.85 | 3.24-3.20 | vw |
| 28.01-28.30 | 3.18-3.15 | vw |
| 28.74-29.06 | 3.10-3.07 | w |
| 30.28-30.62 | 2.95-2.92 | w |
| 30.94-31.28 | 2.89-2.86 | vw |
| 32.26-32.62 | 2.77-2.74 | vw |
| 33.04-33.43 | 2.71-2.68 | vw |
| 34.40-34.81 | 2.60-2.57 | vw |
| 35.27-35.68 | 2.54-2.51 | vw |
| 35.94-36.37 | 2.50-2.47 | vw |

Another aspect of the invention is a process for making a catalyst composition. In one embodiment, the process comprises providing aluminoborate and combining the aluminoborate with a soluble salt in water to form a mixture. The mixture is heated to form a salt modified aluminoborate catalyst composition having a weight ratio Al:B in a range of 1.5 to 2.5; wherein a weight ratio of solid:liquid in the mixture is in a range of 1:20 to 1:100 and the mixture is heated at a temperature in a range of 20° C. to 40° C.; or wherein a weight ratio of solid:liquid in the mixture is in a range of 1:10 to 1:40 and the mixture is heated at a temperature in a range of 50° C. to 100° C.

In some embodiments, providing aluminoborate comprises combining alumina and boric acid; heating the combination of alumina and boric acid at a temperature in a range of 170° C. to 220° C. to form the aluminoborate.

In some embodiments, the process further comprises adding a compound comprising an M²⁺ cation or an M³⁺ cation to the alumina and boric acid.

In some embodiments, the M²⁺ cation or the M³⁺ cation comprises Mg, Ca, Ni, Mn, Co, Zn, Fe, Cr, Rh, Ga, In, Mn, Ti, or combinations thereof.

In some embodiments, the salt modified aluminoborate can be calcined. The calcined samples showed higher Bronsted acidity and lower Lewis acidity compared to a gamma alumina. The calcined material did not have the naphthene make that is typically observed for gamma alumina.

The calcination temperature can produce calcined salt modified aluminoborates having different XRD diffraction patterns.

When the salt modified aluminoborate is calcined at a temperature less than or equal to 425° C., the XRD diffraction pattern is:

TABLE 4
Low Temperature Calcined Type 1

| 2θ ° | d-spacing Å | Intensity |
|---|---|---|
| 7.88-7.96 | 11.22-11.09 | vs |
| 13.28-13.43 | 6.66-6.59 | w |
| 13.73-13.89 | 6.45-6.37 | w |
| 15.49-15.67 | 5.71-5.65 | w |
| 15.89-16.05 | 5.57-5.52 | vw |
| 17.44-17.61 | 5.08-5.03 | w |
| 20.78-21.02 | 4.27-4.22 | vw |
| 21.10-21.36 | 4.21-4.16 | vw |
| 22.29-22.51 | 3.99-3.95 | vw |
| 23.68-23.92 | 3.75-3.72 | vw-w |
| 23.98-24.22 | 3.71-3.67 | vw |
| 25.59-25.88 | 3.48-3.44 | vw |
| 27.54-27.82 | 3.24-3.20 | vw |
| 28.03-28.34 | 3.18-3.15 | vw |
| 28.71-29.02 | 3.11-3.07 | w |
| 30.29-30.61 | 2.95-2.92 | w |
| 30.89-31.21 | 2.89-2.86 | vw |
| 32.19-32.56 | 2.78-2.75 | vw |
| 32.98-33.36 | 2.71-2.68 | vw |
| 34.45-34.80 | 2.60-2.58 | vw |
| 35.24-35.61 | 2.54-2.52 | vw |
| 35.87-36.28 | 2.50-2.47 | vw |

When the salt modified aluminoborate is calcined at a temperature range of 450° C. to 700° C., the calcined salt modified aluminoborate catalyst composition has an XRD diffraction pattern of:

TABLE 5
High Temperature Calcined Type 1

| 2θ ° | d-spacing Å | Intensity |
|---|---|---|
| 7.97-8.05 | 11.08-10.97 | vs |
| 13.44-13.57 | 6.58-6.52 | m |
| 14.03-14.17 | 6.31-6.24 | m |
| 15.70-15.85 | 5.64-5.59 | m |
| 17.63-17.81 | 5.03-4.98 | w |
| 21.16-21.38 | 4.19-4.15 | w |
| 22.56-22.79 | 3.94-3.90 | w |
| 24.06-24.30 | 3.70-3.66 | w |
| 26.16-26.43 | 3.40-3.37 | vw |
| 28.27-28.56 | 3.15-3.12 | w |
| 29.05-29.34 | 3.07-3.04 | w |
| 30.74-31.05 | 2.91-2.88 | w |

Unmodified aluminoborates can be calcined at higher temperatures than the temperatures used above without losing the sharp XRD diffraction pattern.

### EXAMPLES

### Modifications of Aluminoborates Increasing Surface Area and Adjusting Al:B Ratio

In a typical synthesis of a starting aluminoborate material, 1.04 g of V-251 boehmite was added to a Teflon lined stainless steel autoclave with 3.09 g of boric acid. The sample was sealed, placed in an oven, and heated under autogenous pressure at 200° C. for 4 days. The sample was then ground and placed in hot (about 65° C.) DI water and filtered. Table 6 outlines other synthesis conditions and starting materials that yield a similar aluminoborate phase.

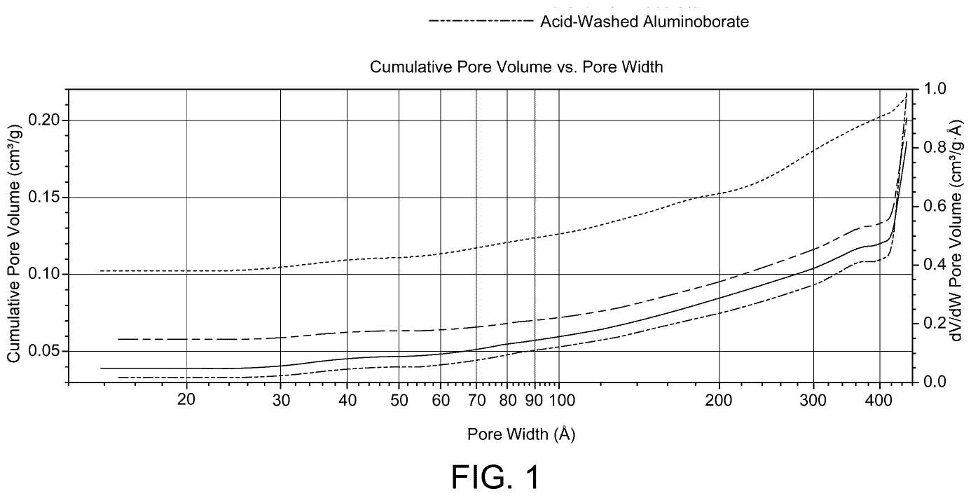

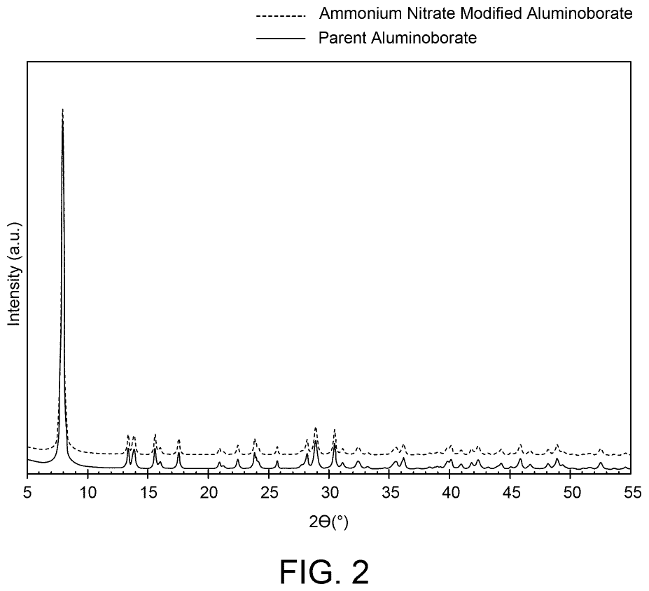

The ammonium modified aluminoborates have an increased micropore volume relative to the starting material, without an increase in the mesopore volumes based on surface area data. This increase in pore volume was not observed for either a nitric acid wash or water only washes at room temperatures as shown in FIG. 1. Similar results were seen at room temperature. The XRD patterns before and after the salt modification are virtually superimposable (FIG. 2).

Using an Autosorb 6200 (available from Anton Paar USA Inc.), the microporosity was modeled using a DFT pore size model. The data of a parent and a modified sample are shown in FIG. 8. There is a clear increase in the volume of the larger micropore (18 ring) centered at approximately 5.5 Å.

Samples were tested for the adsorption of trifluoroacetic acid (TFA) (Table 8).

TABLE 6
Aluminoborate starting material syntheses.

| | | | | | Temper- | |
|---|---|---|---|---|---|---|
| Sample | | Mass | | Mass | ature | |
| number | R1 | R1 | R2 | R2 | ° C. | Time |
| A | H3BO3 | 3.09 | boehmite | 1.7131 | 200 | 4 d |
| B | H3BO3 | 3.09 | gibbsite | 1.5609 | 200 | 4 d |
| C | H3BO3 | 3.09 | boehmite | 1.71 | 200 | 1 d |
| D | H3BO3 | 3.09 | boehmite | 1.71 | 200 | 4 d |
| E | H3BO3 | 3.09 | boehmite | 1.71 | 170 | 4 d |
| F | H3BO3 | 3.09 | boehmite | 1.71 | 170 | 1 d |
| G | H3BO3 | 3.09 | boehmite | 1.72 | 200 | 2 d |
| H | H3BO3 | 3.09 | boehmite | 1.72 | 200 | 3 d |
| I | H3BO3 | 3.09 | bayerite | 1.5599 | 200 | 4 d |
| J | H3BO3 | 3.09 | boehmite | 0.3493 | 200 | 4 d |
| K | H3BO3 | 3.09 | boehmite | 0.6978 | 200 | 4 d |
| L | H3BO3 | 3.09 | boehmite | 1.048 | 200 | 4 d |
| M | H3BO3 | 3.09 | boehmite | 1.3964 | 200 | 4 d |
| N | H3BO3 | 3.09 | boehmite | 1.3976 | 200 | 4 d |
| O | H3BO3 | 3.08 | boehmite | 1.3964 | 200 | 4 d |
| P | H3BO3 | 3.08 | boehmite | 1.3964 | 200 | 4 d |
| Q | H3BO3 | 6.20 | boehmite | 2.80 | 200 | 6 d |
| R | H3BO3 | 3.14 | Flash calcined | 0.97 | 200 | 5 d |
| | | | alumina | | | |
| S | H3BO3 | 3.09 | gamma alumina | 1.01 | 200 | 5 d |
| T | H3BO3 | 6.21 | boehmite | 2.81 | 200 | 5 d |
| U | H3BO3 | 3.1 | boehmite | 1.01 | 200 | 1 D |
| V | H3BO3 | 3.09 | boehmite | 1.00 | 200 | 2 D |
| W | H3BO3 | 3.11 | boehmite | 1.01 | 200 | 2 D |
| X | H3BO3 | 3.11 | boehmite | 1.01 | 200 | 2 D |
| Y | H3BO3 | 309.15 | boehmite | 104 | 200 | 6 d |
| Z | H3BO3 | 309.00 | boehmite | 104 | 200 | 6 d |
| AA | H3BO3 | 309.09 | boehmite | 104.2 | 200 | 5 d |

TABLE 7
Aluminoborate modification conditions yielding a similar phase.

| | Parent | | Salt | Molar | | | |
|---|---|---|---|---|---|---|---|
| Sample | Sample | Salt | Added | Mass | Water | Concentration | Temperature |
| Label | (g) | Identity | (g) | (g/mol) | (g) | (M) | (° C.) |
| AB | 10.02 | NH4NO3 | 8.02 | 80.06 | 1000.2 | 0.1 | 25 |
| AC | 10.02 | NH4NO3 | 1.64 | 80.06 | 200.10 | 0.1 | 60 |
| AD | 5.03 | NH4NO3 | 4.07 | 80.06 | 100.35 | 0.51 | 60 |
| AE | 1.01 | NH4NO3 | 0.90 | 80.06 | 100.00 | 0.11 | 25 |
| AF | 2.04 | NH4NO3 | 1.90 | 80.06 | 199.50 | 0.12 | 25 |
| AG | 5.00 | NH4NO3 | 0.80 | 80.06 | 100.00 | 0.1 | 60 |
| AH | 5.02 | NH4NO3 | 0.82 | 80.06 | 102.93 | 0.1 | 60 |
| AI | 3.01 | NH4C1 | 0.32 | 53.49 | 60.05 | 0.1 | 60 |
| AJ | 3.00 | NaNO3 | 0.51 | 84.99 | 60.04 | 0.1 | 60 |
| AK | 3.00 | NaCl | 0.36 | 58.44 | 60.06 | 0.1 | 60 |
| AL | 10.03 | NH4NO3 | 2.42 | 80.06 | 300.04 | 0.1 | 60 |

TABLE 8
TFA adsorption of aluminoborate and activated carbon from
a materials from a 290 ppm fluoride solution. The best
performing aluminoborate material is a type 2 material.

| Solid Adsorbent | % TFA Absorbed |
|---|---|
| Type 2 | 37 |
| Type 1 | 25 |
| Activated Carbon | 1.1 |

### Synthesis of Starting Material

### Example 1

### Synthesis

In a typical synthesis of the PKU-1-like AlBO, 104 g of boehmite (V-251) was combined with 309 g of boric acid directly in a 2 L PTFE liner. The sample was then sealed in a 2 L static autoclave and placed in an oven at 200° C. The autoclave was heated under static conditions and allowed to react at autogenous pressure for a period of 6 days.

### Example 2

### Synthesis

In a typical synthesis of the PKU-1-like AlBO, 1.39 g of boehmite (V-251) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 6 days.

### Example 3

### Synthesis

In a typical synthesis of the PKU-1-like AlBO, 1.56 g of gibbsite was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Example 4

### Synthesis

In a typical synthesis of the PKU-1-like AlBO, 1.56 g of bayerite was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Example 5

### Synthesis

In a typical synthesis of the PKU-1-like AlBO, 0.97 g of flash calcined alumina (FCA) was combined with 3.14 g of boric acid directly in a 45 cc PTFE liner. The sample was then sealed in a 45 cc static autoclave and placed in an oven at 200° C. The autoclave was heated under static conditions and allowed to react at autogenous pressure for a period of 5 days.

### Example 6

### Synthesis

In a typical synthesis of the PKU-1-like AlBO, 1.01 g of gamma alumina (VGL-25) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 5 days.

### Example 7

### Synthesis

In a typical synthesis of the PKU-1-like AlBO, 1.71 g of boehmite (V-251) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Modification of Aluminoborate

### Example 8

### Modification

In a typical modification of the aluminoborate material, 1.01 g of the parent aluminoborate material was added to 100 g of DI water, followed by 0.9 g of ammonium nitrate.

The sample was held at 25° C. with stirring for 3 h, then filtered and dried in an oven. Table 7 outlines other modification conditions that yield a similar modified aluminoborate phase.

### Example 9

### Modification

In a typical modification of the aluminoborate material, 10.02 g of the parent aluminoborate material was added to 1000.2 g of DI water, followed by 8.02 g of ammonium nitrate. The sample was held at 25° C. with stirring for 3 h, then filtered and dried in an oven. Table 7 outlines other modification conditions that yield a similar modified aluminoborate phase.

### Example 10

### Modification

In a typical modification of the aluminoborate material, 10.02 g of the parent aluminoborate material was added to 200.1 g of DI water, followed by 1.64 g of ammonium nitrate.

The sample was held at 60° C. with stirring for 3 h, then filtered and dried in an oven. Table 7 outlines other modification conditions that yield a similar modified aluminoborate phase.

### Example 11

### Modification

In a typical modification of the aluminoborate material, 5.00 g of the parent aluminoborate material was added to 100.00 g of DI water, followed by 0.80 g of ammonium nitrate. The sample was held at 60° C. with stirring for 3 h, then filtered and dried in an oven. Table 7 outlines other modification conditions that yield a similar modified aluminoborate phase.

### Example 12

### Modification

In a typical modification of the aluminoborate material, 3.01 g of the parent aluminoborate material was added to 60.05 g of DI water, followed by 0.32 g of ammonium chloride. The sample was held at 60° C. with stirring for 3 h, then filtered and dried in an oven. Table 7 outlines other modification conditions that yield a similar modified aluminoborate phase.

### Example 13

### Modification

In a typical modification of the aluminoborate material, 3.00 g of the parent aluminoborate material was added to 60.04 g of DI water, followed by 0.51 g of sodium nitrate. The sample was held at 60° C. with stirring for 3 h, then filtered and dried in an oven. Table 7 outlines other modification conditions that yield a similar modified aluminoborate phase.

### Example 14

### Modification

In a typical modification of the aluminoborate material, 3.00 g of the parent aluminoborate material was added to 58.44 g of DI water, followed by 0.36 g of sodium chloride. The sample was held at 60° C. with stirring for 3 h, then filtered and dried in an oven. Table 7 outlines other modification conditions that yield a similar modified aluminoborate phase.

### Calcined M-AIBO-1

### Example 15-37287-31-400C

A total of 4.19 g of the material made in Example 3 was ground and weighed in a calcination dish. The dish was then placed in a furnace at 100° C. that was subsequently ramped at a rate of 2° C./min to 400° C. with a programmed dwelling step of 3 h at that temperature. The furnace was then programmed to cool naturally to 100° C. and the furnace was held at that temperature until the material was removed. The resulting product was then analyzed against the parent material with both XRD and surface area. The XRD revealed the same number and roughly the same relative intensities of the parent material.

TABLE 9

| 2θ ° | d-spacing Å | Intensity |
|---|---|---|
| 7.92 | 11.15 | vs |
| 13.34 | 6.63 | w |
| 13.82 | 6.40 | w |
| 15.57 | 5.69 | w |
| 15.97 | 5.55 | vw |
| 17.53 | 5.06 | w |
| 20.91 | 4.24 | vw |
| 21.25 | 4.18 | vw |
| 22.40 | 3.97 | vw |
| 23.80 | 3.74 | vw |
| 24.10 | 3.69 | vw |
| 25.72 | 3.46 | vw |
| 27.68 | 3.22 | vw |
| 28.17 | 3.17 | vw |
| 28.88 | 3.09 | w |
| 30.44 | 2.93 | w |
| 31.05 | 2.88 | vw |
| 32.40 | 2.76 | vw |
| 33.19 | 2.70 | vw |
| 34.63 | 2.59 | vw |
| 35.44 | 2.53 | vw |
| 36.10 | 2.49 | vw |

### Example 16-37287-31-600C

A total of 4.16 g of the material made in Example 3 was ground and weighed in a calcination dish. The dish was then placed in a furnace at 100° C. that was subsequently ramped at a rate of 2° C./min to 600° C. with a programmed dwelling step of 3 h at that temperature. The furnace was then programmed to cool naturally to 100° C. and the furnace was held at that temperature until the material was removed. The resulting product was then analyzed against the parent material with both XRD and surface area. Relative to the parent material, there was a significant loss in crystallinity of the diffraction pattern and a reduction in the total number of peaks as well as the emergence of a poorly crystalline phase. The more crystalline phase is characterized by the following diffraction lines:

TABLE 10

| 2θ ° | d-spacing Å | Intensity |
|---|---|---|
| 8.01 | 11.03 | vs |
| 13.50 | 6.55 | m |
| 14.10 | 6.28 | m |
| 15.78 | 5.61 | m |
| 17.72 | 5.00 | w |
| 21.27 | 4.17 | w |
| 22.67 | 3.92 | w |
| 24.18 | 3.68 | w |
| 26.29 | 3.39 | vw |
| 28.42 | 3.14 | w |
| 29.19 | 3.06 | w |
| 30.89 | 2.89 | w |

The calcined materials have been tested for heptene isomerization. Table 11 shows the normalized microreactor data for the Type 1 and Type 2 materials calcined at 400 C and 600 C normalized to the conversion and selectivity of the Type 1 ammonium nitrate modified aluminoborate calcined at 400 C.

TABLE 11

| Sample | Relative Conversion 400 C. | Relative selectivity 400 C. |
|---|---|---|
| Type 1 400 C. | 1.00 | 1.00 |
| Type 1 600 C. | 1.20 | 2.53 |
| Type 2 400 C. | 1.19 | 2.62 |
| Type 2 600 C. | 1.23 | 4.03 |

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising a salt modified aluminoborate having a weight ratio of Al/B in a range of 1.5 to 2.5. An embodiment of the invention is one, any or all of prior embodiments in this paragraph up through the first embodiment in this paragraph wherein the salt modified aluminoborate has a surface area of 147 m²/g to 443 m²/g. An embodiment of the invention is one, any or all of prior embodiments in this paragraph up through the first embodiment in this paragraph wherein the salt modified aluminoborate has a total pore volume in a range of 0.18 cc/g to 0.4 cc/g. An embodiment of the invention is one, any or all of prior embodiments in this paragraph up through the first embodiment in this paragraph wherein the salt modified aluminoborate has a mesopore volume in a range of 0.09 cc/g to 0.26 cc/g. An embodiment of the invention is one, any or all of prior embodiments in this paragraph up through the first embodiment in this paragraph wherein the salt modified aluminoborate has a micropore volume in a range of 0.05 cc/g to 0.13 cc/g. An embodiment of the invention is one, any or all of prior embodiments in this paragraph up through the first embodiment in this paragraph wherein the salt modified aluminoborate is modified with a salt of ammonium, Li, K, Na, Rb, Cs, Mg, Ca, Sr, Ba, or combinations thereof. An embodiment of the invention is one, any or all of prior embodiments in this paragraph up through the first embodiment in this paragraph wherein the salt modified aluminoborate further comprises an M²⁺ cation or an M³⁺ cation. An embodiment of the invention is one, any or all of prior embodiments in this paragraph up through the first embodiment in this paragraph wherein a metal of the M²⁺ cation or the M³⁺ cation comprises Mg, Ca, Ni, Mn, Co, Zn, Fe, Cr, Rh, Ga, In, Mn, Ti, La, or combinations thereof. An embodiment of the invention is one, any or all of prior embodiments in this paragraph up through the first embodiment in this paragraph wherein the salt modified aluminoborate comprises a calcined salt modified aluminoborate, and wherein the calcined salt modified aluminoborate has an XRD diffraction pattern of:

TABLE 4

| 2θ ° | d-spacing Å | Intensity |
|---|---|---|
| 7.88-7.96 | 11.22-11.09 | vs |
| 13.28-13.43 | 6.66-6.59 | w |
| 13.73-13.89 | 6.45-6.37 | w |
| 15.49-15.67 | 5.71-5.65 | w |
| 15.89-16.05 | 5.57-5.52 | vw |
| 17.44-17.61 | 5.08-5.03 | w |
| 20.78-21.02 | 4.27-4.22 | vw |
| 21.10-21.36 | 4.21-4.16 | vw |
| 22.29-22.51 | 3.99-3.95 | vw |
| 23.68-23.92 | 3.75-3.72 | vw-w |
| 23.98-24.22 | 3.71-3.67 | vw |
| 25.59-25.88 | 3.48-3.44 | vw |
| 27.54-27.82 | 3.24-3.20 | vw |
| 28.03-28.34 | 3.18-3.15 | vw |
| 28.71-29.02 | 3.11-3.07 | w |
| 30.29-30.61 | 2.95-2.92 | w |
| 30.89-31.21 | 2.89-2.86 | vw |
| 32.19-32.56 | 2.78-2.75 | vw |
| 32.98-33.36 | 2.71-2.68 | vw |
| 34.45-34.80 | 2.60-2.58 | vw |
| 35.24-35.61 | 2.54-2.52 | vw |
| 35.87-36.28 | 2.50-2.47 | vw |

An embodiment of the invention is one, any or all of prior embodiments in this paragraph up through the first embodiment in this paragraph wherein the salt modified aluminoborate comprises a calcined salt modified aluminoborate, and wherein the calcined salt modified aluminoborate has an XRD diffraction pattern of:

TABLE 5

| 2θ ° | d-spacing Å | Intensity |
|---|---|---|
| 7.97-8.05 | 11.08-10.97 | vs |
| 13.44-13.57 | 6.58-6.52 | m |
| 14.03-14.17 | 6.31-6.24 | m |
| 15.70-15.85 | 5.64-5.59 | m |
| 17.63-17.81 | 5.03-4.98 | w |
| 21.16-21.38 | 4.19-4.15 | w |
| 22.56-22.79 | 3.94-3.90 | w |
| 24.06-24.30 | 3.70-3.66 | w |
| 26.16-26.43 | 3.40-3.37 | vw |
| 28.27-28.56 | 3.15-3.12 | w |
| 29.05-29.34 | 3.07-3.04 | w |
| 30.74-31.05 | 2.91-2.88 | w |

A second embodiment of the invention is a process for making a catalyst composition providing aluminoborate; combining the aluminoborate with a soluble salt in water to form a mixture; heating the mixture to form a salt modified aluminoborate catalyst composition having a weight ratio Al/B in a range of 1.5 to 2.5; wherein a weight ratio of solid:liquid in the mixture is in a range of 1:20 to 1:100 and the mixture is heated at a temperature in a range of 20° C. to 40° C.; or wherein a weight ratio of solid:liquid in the mixture is in a range of 1:10 to 1:40 and the mixture is heated at a temperature in a range of 50° C. to 100° C. An embodiment of the invention is one, any or all of prior embodiments in this paragraph up through the second embodiment in this paragraph wherein providing aluminoborate comprises combining alumina and boric acid; heating the combination of alumina and boric acid at a temperature in a range of 170° C. to 220° C. to form the aluminoborate. An embodiment of the invention is one, any or all of prior embodiments in this paragraph up through the second embodiment in this paragraph further comprising adding a compound comprising an M²⁺ cation or an M³⁺ cation to the alumina and boric acid. An embodiment of the invention is one, any or all of prior embodiments in this paragraph up through the second embodiment in this paragraph wherein the M²⁺ cation or the M³⁺ cation comprises Mg, Ca, Ni, Mn, Co, Zn, Fe, Cr, Rh, Ga, In, Mn, Ti, La, or combinations thereof. An embodiment of the invention is one, any or all of prior embodiments in this paragraph up through the second embodiment in this paragraph further comprising calcining the salt modified aluminoborate catalyst composition at a temperature less than or equal to 425° C. to form a calcined salt modified aluminoborate catalyst composition having an XRD diffraction pattern of:

TABLE 4

| 2θ ° | d-spacing Å | Intensity |
|---|---|---|
| 7.88-7.96 | 11.22-11.09 | vs |
| 13.28-13.43 | 6.66-6.59 | w |
| 13.73-13.89 | 6.45-6.37 | w |
| 15.49-15.67 | 5.71-5.65 | w |
| 15.89-16.05 | 5.57-5.52 | vw |
| 17.44-17.61 | 5.08-5.03 | w |
| 20.78-21.02 | 4.27-4.22 | vw |
| 21.10-21.36 | 4.21-4.16 | vw |
| 22.29-22.51 | 3.99-3.95 | vw |
| 23.68-23.92 | 3.75-3.72 | vw-w |
| 23.98-24.22 | 3.71-3.67 | vw |
| 25.59-25.88 | 3.48-3.44 | vw |
| 27.54-27.82 | 3.24-3.20 | vw |
| 28.03-28.34 | 3.18-3.15 | vw |
| 28.71-29.02 | 3.11-3.07 | w |
| 30.29-30.61 | 2.95-2.92 | w |
| 30.89-31.21 | 2.89-2.86 | vw |
| 32.19-32.56 | 2.78-2.75 | vw |
| 32.98-33.36 | 2.71-2.68 | vw |
| 34.45-34.80 | 2.60-2.58 | vw |
| 35.24-35.61 | 2.54-2.52 | vw |
| 35.87-36.28 | 2.50-2.47 | vw |

An embodiment of the invention is one, any or all of prior embodiments in this paragraph up through the second embodiment in this paragraph further comprising calcining the salt modified aluminoborate catalyst composition at a temperature in a range of 450° C. to 700° C. to form a 5 calcined salt modified aluminoborate catalyst composition having an XRD diffraction pattern of:

TABLE 5

| 2θ ° | d-spacing Å | Intensity |
|---|---|---|
| 7.97-8.05 | 11.08-10.97 | vs |
| 13.44-13.57 | 6.58-6.52 | m |
| 14.03-14.17 | 6.31-6.24 | m |
| 15.70-15.85 | 5.64-5.59 | m |
| 17.63-17.81 | 5.03-4.98 | w |
| 21.16-21.38 | 4.19-4.15 | w |
| 22.56-22.79 | 3.94-3.90 | w |
| 24.06-24.30 | 3.70-3.66 | w |
| 26.16-26.43 | 3.40-3.37 | vw |
| 28.27-28.56 | 3.15-3.12 | w |
| 29.05-29.34 | 3.07-3.04 | w |
| 30.74-31.05 | 2.91-2.88 | w |

An embodiment of the invention is one, any or all of prior embodiments in this paragraph up through the second embodiment in this paragraph wherein the salt modified aluminoborate has a surface area of 147 m²/g to 443 m²/g. An embodiment of the invention is one, any or all of prior embodiments in this paragraph up through the second embodiment in this paragraph wherein the salt modified aluminoborate has a total pore volume in a range of 0.18 cc/g to 0.4 cc/g; or wherein the salt modified aluminoborate has a mesopore volume in a range of 0.09 cc/g to 0.26 cc/g; or wherein the salt modified aluminoborate has a micropore volume in a range of 0.05 cc/g to 0.13 cc/g; or combinations thereof. An embodiment of the invention is one, any or all of prior embodiments in this paragraph up through the second embodiment in this paragraph wherein the soluble salt comprises a salt of ammonium, Li, K, Na, Rb, Cs, Mg, Ca, Sr, Ba, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst composition comprising:
a salt modified aluminoborate having a weight ratio of Al:B in a range of 1.5 to 2.5.

2. The catalyst composition of claim 1 wherein the salt modified aluminoborate has a surface area of 147 m²/g to 443 m²/g.

3. The catalyst composition of claim 1 wherein the salt modified aluminoborate has a total pore volume in a range of 0.18 cc/g to 0.4 cc/g.

4. The catalyst composition of claim 1 wherein the salt modified aluminoborate has a mesopore volume in a range of 0.09 cc/g to 0.26 cc/g.

5. The catalyst composition of claim 1 wherein the salt modified aluminoborate has a micropore volume in a range of 0.05 cc/g to 0.13 cc/g.

6. The catalyst composition of claim 1 wherein the salt modified aluminoborate is modified with a salt of ammonium, Li, K, Na, Rb, Cs, Mg, Ca, Sr, Ba, or combinations thereof.

7. The catalyst composition of claim 1 wherein the salt modified aluminoborate further comprises an M²⁺ cation or an M³⁺ cation.

8. The catalyst composition of claim 6 wherein a metal of the M²⁺ cation or the M³⁺ cation comprises Mg, Ca, Ni, Mn, Co, Zn, Fe, Cr, Rh, Ga, In, Mn, Ti, La, or combinations thereof.

9. The catalyst composition of claim 1 wherein the salt modified aluminoborate comprises a calcined salt modified aluminoborate, and wherein the calcined salt modified aluminoborate has an XRD diffraction pattern of:
TABLE 4

| 2θ ° | d-spacing Å | Intensity |
|---|---|---|
| 7.88-7.96 | 11.22-11.09 | vs |
| 13.28-13.43 | 6.66-6.59 | w |
| 13.73-13.89 | 6.45-6.37 | w |
| 15.49-15.67 | 5.71-5.65 | w |
| 15.89-16.05 | 5.57-5.52 | vw |
| 17.44-17.61 | 5.08-5.03 | w |
| 20.78-21.02 | 4.27-4.22 | vw |
| 21.10-21.36 | 4.21-4.16 | vw |
| 22.29-22.51 | 3.99-3.95 | vw |
| 23.68-23.92 | 3.75-3.72 | vw-w |
| 23.98-24.22 | 3.71-3.67 | vw |
| 25.59-25.88 | 3.48-3.44 | vw |
| 27.54-27.82 | 3.24-3.20 | vw |
| 28.03-28.34 | 3.18-3.15 | vw |
| 28.71-29.02 | 3.11-3.07 | w |
| 30.29-30.61 | 2.95-2.92 | w |
| 30.89-31.21 | 2.89-2.86 | vw |
| 32.19-32.56 | 2.78-2.75 | vw |
| 32.98-33.36 | 2.71-2.68 | vw |
| 34.45-34.80 | 2.60-2.58 | vw |
| 35.24-35.61 | 2.54-2.52 | vw |
| 35.87-36.28 | 2.50-2.47 | vw |

10. The catalyst composition of claim 1 wherein the salt modified aluminoborate comprises a calcined salt modified aluminoborate, and wherein the calcined salt modified aluminoborate has an XRD diffraction pattern of:
TABLE 5

| 2θ ° | d-spacing Å | Intensity |
|---|---|---|
| 7.97-8.05 | 11.08-10.97 | vs |
| 13.44-13.57 | 6.58-6.52 | m |
| 14.03-14.17 | 6.31-6.24 | m |
| 15.70-15.85 | 5.64-5.59 | m |
| 17.63-17.81 | 5.03-4.98 | w |
| 21.16-21.38 | 4.19-4.15 | w |
| 22.56-22.79 | 3.94-3.90 | w |
| 24.06-24.30 | 3.70-3.66 | w |
| 26.16-26.43 | 3.40-3.37 | vw |
| 28.27-28.56 | 3.15-3.12 | w |
| 29.05-29.34 | 3.07-3.04 | w |
| 30.74-31.05 | 2.91-2.88 | w |

11. The process of claim 1 wherein the salt modified aluminoborate has more BO₃-1 environment than the parent aluminoborate and less BO₃-2 environment than the parent aluminoborate.

12. A process for making a catalyst composition:
providing aluminoborate;
combining the aluminoborate with a soluble salt in water to form a mixture; and
heating the mixture to form a salt modified aluminoborate catalyst composition having a weight ratio Al:B in a range of 1.5 to 2.5;
wherein a weight ratio of solid:liquid in the mixture is in a range of 1:20 to 1:100 and the mixture is heated at a temperature in a range of 20° C. to 40° C.; or
wherein a weight ratio of solid:liquid in the mixture is in a range of 1:10 to 1:40 and the mixture is heated at a temperature in a range of 50° C. to 100° C.

13. The process of claim 12 wherein providing aluminoborate comprises:
combining alumina and boric acid; and
heating the combination of alumina and boric acid at a temperature in a range of 170° C. to 220° C. to form the aluminoborate.

14. The process of claim 13 further comprising:
adding a compound comprising an M²⁺ cation or an M³⁺ cation to the alumina and boric acid.

15. The process of claim 14 wherein the M²⁺ cation or the M³⁺ cation comprises Mg, Ca, Ni, Mn, Co, Zn, Fe, Cr, Rh, Ga, In, Mn, Ti, La, or combinations thereof.

16. The process of claim 12 further comprising:
calcining the salt modified aluminoborate catalyst composition at a temperature less than or equal to 425° C. to form a calcined salt modified aluminoborate catalyst composition having an XRD diffraction pattern of:
TABLE 4

| 2θ ° | d-spacing Å | Intensity |
|---|---|---|
| 7.88-7.96 | 11.22-11.09 | vs |
| 13.28-13.43 | 6.66-6.59 | w |
| 13.73-13.89 | 6.45-6.37 | w |
| 15.49-15.67 | 5.71-5.65 | w |
| 15.89-16.05 | 5.57-5.52 | vw |
| 17.44-17.61 | 5.08-5.03 | w |
| 20.78-21.02 | 4.27-4.22 | vw |
| 21.10-21.36 | 4.21-4.16 | vw |
| 22.29-22.51 | 3.99-3.95 | vw |
| 23.68-23.92 | 3.75-3.72 | vw-w |
| 23.98-24.22 | 3.71-3.67 | vw |
| 25.59-25.88 | 3.48-3.44 | vw |
| 27.54-27.82 | 3.24-3.20 | vw |
| 28.03-28.34 | 3.18-3.15 | vw |
| 28.71-29.02 | 3.11-3.07 | w |
| 30.29-30.61 | 2.95-2.92 | w |
| 30.89-31.21 | 2.89-2.86 | vw |
| 32.19-32.56 | 2.78-2.75 | vw |
| 32.98-33.36 | 2.71-2.68 | vw |
| 34.45-34.80 | 2.60-2.58 | vw |
| 35.24-35.61 | 2.54-2.52 | vw |
| 35.87-36.28 | 2.50-2.47 | vw |

17. The process of claim 12 further comprising:
calcining the salt modified aluminoborate catalyst composition at a temperature in a range of 450° C. to 700° C. to form a calcined salt modified aluminoborate catalyst composition having an XRD diffraction pattern of:
TABLE 5

| 2θ ° | d-spacing Å | Intensity |
|---|---|---|
| 7.97-8.05 | 11.08-10.97 | vs |
| 13.44-13.57 | 6.58-6.52 | m |
| 14.03-14.17 | 6.31-6.24 | m |
| 15.70-15.85 | 5.64-5.59 | m |
| 17.63-17.81 | 5.03-4.98 | w |
| 21.16-21.38 | 4.19-4.15 | w |
| 22.56-22.79 | 3.94-3.90 | w |
| 24.06-24.30 | 3.70-3.66 | w |
| 26.16-26.43 | 3.40-3.37 | vw |
| 28.27-28.56 | 3.15-3.12 | w |
| 29.05-29.34 | 3.07-3.04 | w |
| 30.74-31.05 | 2.91-2.88 | w |

18. The process of claim 12 wherein the salt modified aluminoborate has a surface area of 147 m²/g to 443 m²/g.

19. The process of claim 12:
wherein the salt modified aluminoborate has a total pore volume in a range of 0.18 cc/g to 0.4 cc/g; or
5 wherein the salt modified aluminoborate has a mesopore volume in a range of 0.09 cc/g to 0.26 cc/g; or
wherein the salt modified aluminoborate has a micropore volume in a range of 0.05 cc/g to 0.13 cc/g;
or combinations thereof.

20. The process of claim 1 wherein the salt modified aluminoborate has more BO₃-1 environment than the parent aluminoborate and less BO₃-2 environment than the parent aluminoborate.
